(19) United States
(12) Patent Application Publication
(10) Pub. No.: US 2010/0145879 A1
(43) Pub. Date: Jun. 10, 2010

(54) SYSTEM AND METHOD FOR GENERATING A LEVERAGED INVESTMENT PLAN TO PROVIDE EDUCATIONAL FUNDS

(76) Inventor: ALFRED G. CALI, Huntington Station, NY (US)

Correspondence Address: TUTUNJIAN + BITETTO, P.C., 20 CROSSWAYS PARK NORTH, SUITE 210, WOODBURY, NY, 11797, US

(21) Appl. No.: 12/701,796

(22) Filed: Feb. 8, 2010

Related U.S. Application Data
(62) Division of application No. 11/800,156, filed on May 4, 2007.

(51) Int. Cl. G06Q 40/00

(52) U.S. Cl. 705/36 R

(57) ABSTRACT

A system and method are provided for developing a leveraged investment plan to cover for higher education costs. The system may have an interface layer, which may have a data input module for entering financial information. The interface layer may further include a counselor/back office override module permitting a user to modify the financial information, or any dependent calculation. The system may further have a middleware layer having a calculation module, a reports module, and a forms module, all connected to data storage in a data storage layer. The calculation module may be configured to generate asset targets based on the financial information entered and the anticipated college costs. The calculation module may then use the asset targets to generate an asset structuring plan having recommendations and strategies for reducing the amount of assets used to calculate financial aid awards. The asset structuring plan may further include recommendations and strategies for leveraging assets to provide income to cover higher educations expenses. The reports module may generate a plurality of reports detailing the asset structuring plan. The forms module may use the financial information entered in conjunction with the asset structuring plan to generate and pre populate financial aid forms for submission to financial aid providers.

### RELATED APPLICATION INFORMATION

This application is a Divisional application of co-pending U.S. patent application Ser. No. 11/800,156 filed on May 4, 2007, incorporated herein by reference in its entirety.

### TECHNICAL FIELD

The present principles generally relate to financial systems, and more particularly, to a system and method for developing a leveraged investment plan to cover educational costs.

### BACKGROUND

Recently, as the costs of higher education have risen, consumers are looking to a wider array of educational funding sources than ever before. In the past, many consumers have leaned heavily on government sponsored grants and loans to pay the costs of higher education. However, many parents borrowing to pay the college education costs for their children may have significant equity in assets such as their homes, other real and personal property, securities and retirement funds that may be accessed without impairing the value of those assets. Furthermore, many federal government and private financial aid plans are based on a combination of the value of the student's and parents' incomes and asset values.

For instance, the Free Application for Federal Student Aid (FAFSA) is an application form for federally subsidized grants and loans required by the federal government before a family is considered for federal financial aid such as grants and government subsidized loans. The FAFSA application process considers the value of parents' assets, including savings, home equity, securities, and the like. Reducing the calculable value of these assets may allow a family to qualify for more federally subsidized financial aid. Additionally, many universities use the calculated results of the FAFSA to determine whether students qualify for funding awarded by the individual universities and private sources.

College Board, under the registered trademarks COLLEGE BOARD® and COLLEGEBOARD.COM®, provides a service under the registered trademark CSS/FINANCIAL AID PROFILE® (hereinafter “PROFILE”) for determining the financial aid eligibility. The PROFILE service offered by College Board provides an alternative method of evaluating the financial aid eligibility of a student. However, in contrast to the FAFSA, PROFILE takes into account the value of the students' or parents' assets when calculating eligibility of student financial aid. Thus, the calculations for financial aid eligibility arrived at by the FAFSA and PROFILE algorithms may differ significantly based on the amount of assets such as the equity in a home and other real property, cash, investments, and the like.

The total applicable amount of assets may also affect the ability of parents to secure federal or institutional financial aid. In some cases, eligibility for financial aid may be eliminated if the totality of the assets exceeds a preset threshold. In such cases, the shifting of assets may be unnecessary, as even when assets are shifted, the totality of assets considered when calculating a student's financial needs may still be higher than the preset threshold.

In such cases, leveraging the assets a family has available may be the most efficient way of financing higher education. However, calculating the optimum leverage and affordability of college costs remains an obstacle.

### SUMMARY

The present principles are directed to a system and method for developing a financing plan to cover educational costs.

Presented is a system for developing an asset structuring plan to provide higher education funding, the system comprising a data storage layer, an interface layer, and a middleware layer. The data storage layer may include a means for storing data, and may optionally be a database.

The interface layer may include a data input module for accepting financial information, and a counselor override module allowing the modification of the financial information. The data input module may be optionally implemented on a website or a spreadsheet.

The middleware layer includes a calculation module that generates an asset structuring plan based on the financial information, and optionally based on the expected cost of higher education. The middleware layer further includes a reports module that generates a plurality of reports detailing the asset structuring plan. The calculation module may optionally be configured to generate the asset structuring plan by calculating the income that would generate securities and annuities purchased with the proceeds from a home refinancing. The calculation module may also optionally be configured to generate asset targets at or below thresholds set by financial aid providers, and to generate an asset structuring plan for lowering the amount of assets used in the financial aid provider's financial aid award calculations.

The calculation module may generate the asset structuring plan in response to a command from a user, with the asset structuring plan stored in data storage after generation. Alternatively, the calculation module may optionally generate the asset structuring plan in response to the financial information being stored in data storage. The reports module may generate the plurality of reports in response to the asset structuring plan being generated. In one embodiment, the reports may optionally be from a group including an asset liquidity report, a plan summary, plan recommendations and strategies, a free cash flow report, a financial aid formula calculations report, and a school expense projections report.

In another embodiment, the middleware layer may further include a forms module configured to load the financial information and the asset structuring plan from data storage, and configured to populate data fields of financial aid forms based on the loaded financial information and asset structuring plan. The forms module may be further configured to transmit the financial data and data from the asset structuring plan to financial aid provider in a predetermined format.

Presented is a method for developing a plan to provide higher education funding. The method includes the steps of determining the financial needs of a future college student, entering the student's family financial information and calculating asset targets. An asset structuring plan based on the asset targets, financial needs and financial information and reports associated with the asset structuring plan is generated, and the asset structuring plan is reviewed by the student's family. Upon determining that changes are required, the method includes adjusting financial information and asset targets, re-calculating the asset targets based on the modified financial information, and re-generating the asset structuring plan. Upon determining that no changes to the asset structuring plan are required, the asset structuring plan is executed. Execution of the asset structuring plan may optionally include refinancing at least one mortgage on real estate, purchasing securities and/or annuities to provide income, purchasing mutual funds to provide income and additional contributions from tax refund monies used to contribute to annuities, purchasing insurance, reallocating assets, and making non-taxable contributions to a pension fund. The method may optionally include generating financial aid forms and populating data fields on the financial aid forms with the financial information and the results of the asset structuring plan.

### BRIEF DESCRIPTION OF THE DRAWINGS

The advantages, nature, and various additional features of the present principles will appear more fully upon consideration of the illustrative embodiments now to be described in detail in connection with accompanying drawings wherein:

FIG. 1 is a flow diagram of a method for developing a higher education financing plan in accordance with the present principles.

FIG. 2 is a block diagram of an illustrative embodiment of a system for developing a higher education financing plan in accordance with the present principles.

It should be understood that the drawings are for purposes of illustrating the concepts of the present principles and are not necessarily the only possible configuration for illustrating the present principles.

### DETAILED DESCRIPTION OF THE INVENTION

The present principles are directed to a system and method for the financing of higher education.

It should be understood that the present principles are described in terms of a system and method for providing financing for higher education; however, the present principles are much broader and may include any financing system. The present principles are described in terms of method steps and software components; however, the concepts of the present principles may be extended to other financing systems and methods.

It should be understood that the elements shown in the Figs. may be implemented in various forms of hardware, software or combinations thereof. Each element may be implemented in any combination of hardware and software, which may be executed on one or more appropriately programmed general-purpose computing devices. The general computing devices may include any combination of any known, or as yet undiscovered, processor, memory or input/output interfaces.

The functions of the various elements shown in the figures may be provided through the use of dedicated hardware as well as hardware capable of executing software in association with appropriate software. When provided by a processor or element, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any elements shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, but not limited to, for example, a combination of circuit elements that performs that function or software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. Any means that can provide those functionalities are equivalent to those shown herein.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended to aid the reader in understanding the present principles and the concepts contributed by the inventor to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, such equivalents may include both currently known equivalents as well as equivalents as yet undeveloped, including any elements developed in the future that perform the same function, regardless of structure.

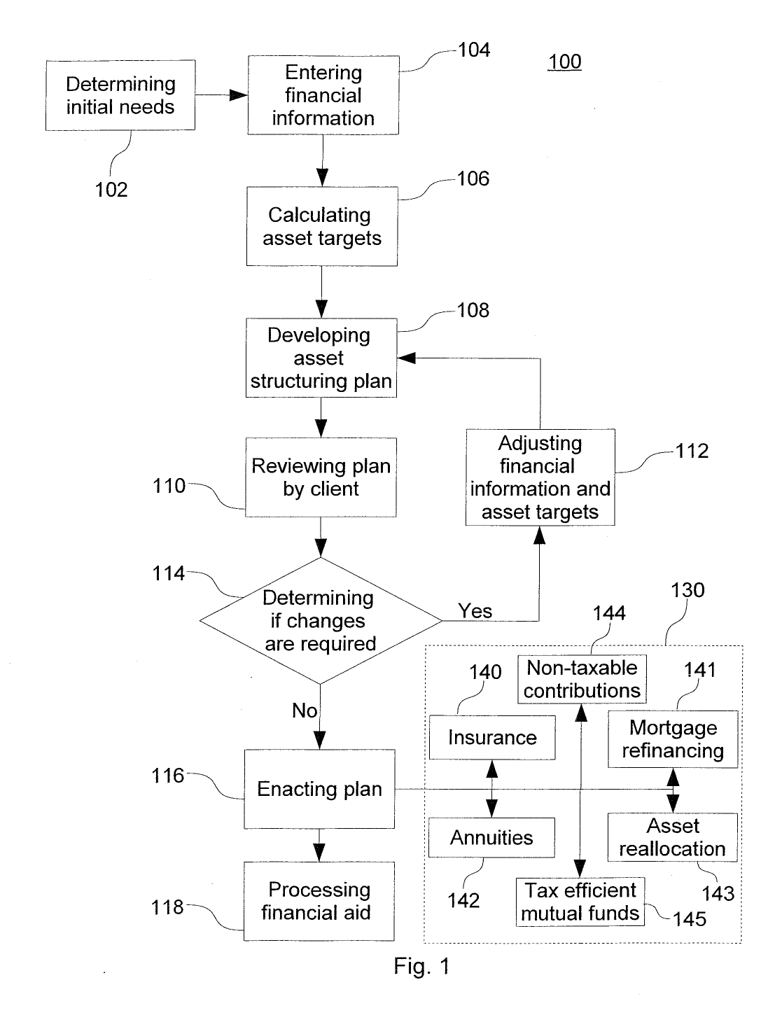

Referring now in specific detail to the drawings in which like reference numerals identify similar or identical elements throughout the several views, and initially to FIG. 1, a flow diagram of a method 100 for developing a higher education financing plan in accordance with the present principles is depicted.

Initially, the needs of the student(s) attending higher education institutes are determined in step 102. In one useful embodiment, this may be determining the anticipated costs associated with attending a higher learning institution, such as tuition, fees, books, housing, transportation, meals, personal expenses, and the like. Of course, it will be immediately recognizable to those skilled in the art of education finance that higher education costs may vary considerably based on numerous factors. For instance, the cost of higher education may depend, but is not limited to, on factors such as whether a particular school is public or private, the location of the school, the anticipated length of schooling, the degree sought, whether the student will be living at the school or commuting, whether the student will be living on- or off-campus, whether the student will be using the institution's dining facilities, and the like.

Information from which to make the initial determination of needs in step 102 may be gathered, in one useful embodiment, by a professional financial advisor, a paper questionnaire, a website, or the like. In such an embodiment, a professional financial may be advantageously able to advise clients on common pitfalls and expectations for higher education costs. Alternatively, the initial needs determination may be estimated based on the particular stated higher education institution that the student will be attending.

Another example of information included in part of an initial determination is the number of students a family has simultaneously in schools. It will be apparent to those of skill in the art that the number of students a family has simultaneously in school affects the financial aid methodology and expected family contributions.

Determining the initial needs in step 102 may also include collecting baseline information regarding the available assets of a client. For example, where a client with little in the way of liquid assets, and no home equity, seeks to finance a college education, asset restructuring and leveraging may not be the best course of action. Alternatively, clients with large amounts of liquid assets, cash, or large home equity balances may be advised on a preliminary basis what options are available, what to expect from the process, and what information they will need to gather for the process.

After the initial needs are determined in step 102, financial information is entered in step 104. In one particularly useful embodiment, the financial information may be entered in via an interface which permits clients to enter their information at a speed, place and time most convenient for the client. In this embodiment, the data entered through a website may be stored directly into a database or the like.

In an alternative, yet equally useful embodiment, financial information may be gathered by a financial advisor from the client, and later entered by the financial advisor into software for immediate or later calculation of an asset structuring plan. After gathering the financial information from the client, the financial advisor may enter the data into the website, a stand-alone data gathering software package, spreadsheet, or other input module.

Once the financial information is entered in step 104, asset targets are calculated in step 106. In determining asset targets, the anticipated costs of higher education are used to determine the initial amount of money needed to pay costs of a students' higher education, as well as regular and future costs associated with the student's education. For example, a student attending a private institution, living on-campus, may have asset target of $15,000 at the beginning of each semester for tuition, fees, and books, and an additional $7,000 at the beginning of each school year for room and board. Additionally, the client may wish to provide the student with a monthly stipend of $300 per month for other incidental expenses. Thus, the total asset targets for this student would be $22,000 at the beginning of each school year, $15,000 at the beginning of the second semesters, and an additional $300 per month.

Conversely, a student working part-time, and who attends a local public institution, lives at home and commutes to school, may, for example, have expected asset targets of $5,000 a semester for tuition, fees and books.

An asset structuring plan is then developed in step 108. If, after determining the initial needs in step 102, and according to the financial information entered in step 104, the client has insufficient assets of which to meaningfully leverage, the client may be able to restructure assets so that the assets are not necessarily calculated by the FAFSA and PROFILE application processes as being available for the client or student to use for higher education funding purposes. In some instances, this may include moving cash and/or securities into qualifying pension plans such as 401 ks or IRAs, making gifts to other children or relatives, or buying any other financial instruments that would not be considered assets for the purposes of calculating the family and student contribution to education costs. However, contributions to retirement plans are generally included in the calculations of financial aid eligibility for the year that the retirement plan contribution was made. Therefore, a contribution to a qualified pension plan may reduce the considered assets for succeeding years, but will not reduce the considered assets for the year the contribution was made. As the contributions to tax deferred retirement plans are not accessible without a substantial penalty until retirement, placing excess liquid assets into a retirement plan may reduce a family's ability to provide income needed to pay educational costs. In such a situation, the purchase of dividend- or interest-bearing annuities or mutual funds may more effectively leverage existing liquid assets.

An alternative tax free contribution may be where a parent contributes to a 529, or college savings plan. Under current guidelines, such 529 plans in a student's name are not currently used to calculate the assets available to students when assessing the student's eligibility for financial aid. Additionally, the removal of the cash used to fund the 529 lowers the considered assets of the parent during the financial aid calculations. Due to recent changes in the laws, the 529 is now considered a contributable asset and therefore is no longer considered in the equations or calculations performed by the present invention.

It should be further noted that, currently, for families with incomes below $50,000 per year, assets are not considered when calculating the contribution expected from the family and student. Thus, the asset restructuring plan may, for a family earning in the $50,000 range, include contributing more annual income to a 401k or other retirement plan, to avoid having other, non-income assets included in the FAFSA calculation of available assets.

Alternatively, where a family (Family A) has income over $50,000 and significant assets, it may be more advantageous to leverage the existing assets to cover college costs instead of moving assets around. This may be because the family has significant assets that cannot be easily moved to a position where they are not included in the FAFSA and PROFILE calculations.

In such an embodiment, assets that have low-interest financing available may be refinanced for higher amounts with the proceeds used to purchase annuities and/or securities bearing higher interest rates than the refinanced loan interest rate. Due to the relatively low interest rates and beneficial tax treatment afforded home mortgages, leveraging the equity of a home may be one of the most effective ways to finance a student's college education.

It should be noted that the amount of the new mortgage taken to refinance any existing mortgage and consolidate any consumer debt or personal loans will vary based on several factors. For instance, where a student will be attending a private institution with relatively high tuition rates, a family may decide to take out a larger home refinancing loan to help pay the associated higher tuition fees. Conversely, a family that desires to avoid assuming a higher home refinancing mortgage may wish to refinance their home for a lower amount, and cover the gap in college tuition costs through savings plans, ordinary income, loans, or the like. These, and other factors, are taken into account when developing an asset structuring plan and calculating the associated home refinancing loan amount.

For example, where a family (Family B) has a home valued at $650,000, the equity in the home is likely very high. Should Family B have a significant amount of equity in the home, the home may be refinanced for an amount greater than is owed on the home, and the proceeds from the refinancing may be used to purchase annuities or tax efficient mutual funds that pay a dividend at a higher interest rate than the refinanced mortgage. Thus, if the Family B owes $150,000 on a home valued at $650,000, $500,000 of equity would be available to finance higher education for children of the household. The asset structuring plan may suggest, for instance, refinancing the home for $500,000, where $150,000 of the refinance amount goes to pay off the original mortgage, leaving $350,000 in cash to use for financing purposes. It should be noted that the $500,000 new mortgage will have higher payments than under the original mortgage, while still leaving $150,000 in equity to the homeowners. However, by purchasing annuities with a rate of return higher than the mortgage interest rate, some of the proceeds from the annuities may be contributed to the mortgage payment to bring the new mortgage payment more in line with the previous mortgage payment.

Additionally, any outstanding, non-mortgage debt, such as personal loans or credit card debt may be consolidated and paid off by the mortgage refinancing. Such consolidation is known to those skilled in the art of finance to improve cash flow, as the interest rate on a mortgage is generally lower than for personal loans and credit cards, and is also tax deductible.

While the mortgage payments on a larger, refinanced mortgage may be higher, and the interest payments on the mortgage will be correspondingly higher, the mortgagee will have a significantly higher federal tax deduction due to the higher home mortgage interest paid each month. The lower tax liability associated with the higher mortgage interest payment will result in a larger tax refund and/or a lower paycheck tax deduction, which may also be used to offset the higher cost of the mortgage, and to pay college costs. Alternatively, the increased tax refunds may be used to purchase annuities as well.

Thus, referring to the example of Family B above, if Family B originally purchased their house for $250,000, after paying for approximately 13 years on a 30 year mortgage, would have paid off $100,000 of principle, with $150,000 of principle left to pay, and monthly payments of $1,500, $1,000 of which would be interest. After securing a 6%, 30 year refinancing mortgage for $500,000, Family B will have mortgage payments of approximately $3,000 per month, with $2,500 of each mortgage payment being interest. Thus, while the new mortgage payments are $1,500 per month higher, there would be an increase in tax deductible interest of $1,500 per month.

The increase in mortgage payment totals $18,000 per year. Furthermore, the increased tax deduction due to interest payment would be $18,000 per year as well. Assuming a 25% nominal tax rate, Family B would reduce their tax liability by $4,500 per year, or $375 per month. ($18,000 per year in additional interest payments*25% nominal tax rate=$4,500 tax savings per year). Thus, when including tax savings, the net increase of the mortgage payments is $13,500 per year.

The cash taken from the mortgage refinance, $350,000, may be advantageously leveraged to provide income that may be used to pay a portion of expected college costs. The asset structuring plan developed in step 108 may include suggestions for purchasing annuities providing a guaranteed return greater than the increase in mortgage payments. For instance, Family B, described above, may use $325,000 of the cash received during the mortgage refinancing to purchase annuities returning an 8% return per year. Skilled practitioners of the financing arts will recognize that, while higher returns may be achieved, higher risks are associated with higher returns. An 8% yearly return on $325,000 of annuities would result in a yearly income of $26,000. ($325,000 *8%=$26,000) Using this income to pay the increased monthly mortgage amount would reduce this income to $12,500 ($26,000 gross annuity income−$13,500 net mortgage increase=$12,500 net annuity income).

In one useful embodiment, the amount of assets that need to be leveraged to provide adequate financing of education may be generated by hand, in software or hardware modules, or through any combination of manual, software or hardware calculation. Furthermore, the leveraged amount may be calculated by taking the desired resulting finance amount, and working backward using anticipated investment returns to arrive at an amount of assets that would need to be leveraged to result in the desired financial returns. Alternatively, a maximum, or target amount of leveraged assets may be used to determine the resulting investment return usable for educational financing.

An additional benefit of refinancing a home and leveraging the equity in a home is that under the PROFILE family contribution and financial aid calculations, home equity is considered to be an asset for the purposes of calculating financial aid eligibility, and the refinancing removes the refinanced amount from the calculation of total assets.

In one useful embodiment, the amounts not used to purchase annuities or mutual funds may be used to purchase life insurance and the like to insulate the parents, who have taken out the larger mortgage, from unforeseen events that may impair their ability to make payments on the mortgage. Some insurance policies such as whole life and universal life policies may also have a cash value at the end of their term, making these insurance policies a form of investment as well as insurance coverage. Similarly, variable universal life insurance policies are a type of cash value life insurance that provide death benefits, and allows for tax deferred growth. Such variable universal life policies allow the insured to select the funds or other investments which the insurance policy premiums are to be invested. Thus, a variable universal life policy may advantageously provide death benefits in addition to a cash payout at the end of the insurance policy term.

Additionally, any additional cash flow created by the mortgage refinancing may be applied to college costs. For instance, if Family B had $30,000 in credit card and personal loan debt which Family B consolidated with cash received from the mortgage refinancing, then most of the amount that would normally have been used to make credit payments may then be used to cover college costs. Generally, monthly payments on revolving credit accounts are 2-3% of the total account balance. With $30,000 of credit card and personal loan debt, Family B would have been paying $600-$900 per month ($6,000-$8,400). Instead of making these payments to credit card companies, this debt may be consolidated by using the proceeds of the mortgage refinancing to pay off the debt, freeing up the $600-$900 per month in cash flow. While using the proceeds from the mortgage refinancing will entail taking out a larger loan in the refinancing, or using less of the proceeds to purchase interest bearing annuities, the benefits gained by settling the higher interest credit card and personal loan debt outweigh the slight increase in payments due to a larger refinancing loan.

In one preferred embodiment, any liquid assets not needed for short term access may also be transferred to an annuity, mutual fund, or other tax efficient investment, which would be sheltered from asset calculations under the FAFSA and PROFILE family contribution and financial aid calculations. Thus, stock and the like may be sheltered from the FAFSA and PROFILE calculations by reinvesting these assets into annuities, tax efficient mutual funds or retirement programs.

In one preferred embodiment, the proceeds from a mortgage refinancing may be used to purchase a single premium immediate annuity (SPIA). Practitioners of the financing arts will recognize that an SPIA is funded by a single premium, and that income from the annuity is available immediately. Furthermore, after the specified term of the annuity runs out, if the annuity purchaser has not withdrawn principal from the annuity, then the initially invested principal may be available to the purchaser at the end of the annuity term.

An alternative to purchasing an SPIA may be purchasing tax efficient mutual funds. In one useful embodiment, the cash received from a home refinancing may be used to purchase shares in mutual funds that provide dividends and reduce the income tax exposure to those dividends and disbursements. For example, tax managed funds, and, to some extent, index funds, assist fund investors in managing their income tax exposure by efficiently matching the sales of high performance stocks with the sales of low performance stocks. The result is that fewer taxes are paid on dividends and disbursements received as income from the fund, due to the dividends and disbursements receiving favorable tax treatment. Under provisions of the current United States Tax Code, certain dividends are taxed at a lower rate than regular income. Similarly, sales of shares owned by a mutual fund may be timed to cause the sales to be considered long-term capital gains, which, when the gains are passed on to mutual fund holders, may be taxed at favorable rates. Of course, this strategy may change with changes in tax regulations, and may be easily adapted to take advantage of other tax incentives or tax law changes.

The corpus, or original amount invested in the mutual fund, may also be withdrawn during the financing plan to provide greater monthly cash flow. This option may be most beneficial to a family that has a significant amount of money invested in a tax efficient mutual fund, and where the family earns an income too large to qualify the family for grants or subsidized loans. For instance, a family earning grater than $125,000 per year would most likely not qualify for subsidized loans or need based grants. The only option for this family would be to use their own income, investments or savings to pay educational costs, or to take out standard, unsubsidized loans. The family may advantageously invest in a tax-efficient mutual fund, and withdraw a small percentage, 1% for example, of the originally invested amount each month to cover educational expenses. This withdrawal would be in addition to receiving any dividends or disbursements from the fund. Depending on the term of the financing plan, the returns generated by the mutual funds, and the original amount invested in the mutual funds, any remaining value of the mutual fund at the end of the term may advantageously be used to pay down any mortgage debt remaining on any real property. Tax efficient mutual funds are known to those practitioners skilled in the to be advantageous over exchange traded mutual funds (ETFs) because they tend to be less volatile than ETFs, decreasing the risk associated with ETFs while conferring greater tax benefits.

A flexible premium deferred annuity (FPDA) calls for multiple payments into an annuity, where the payments are not scheduled or required, and the income is deferred. In one useful embodiment, an FPDA may be arranged in addition to the SPIA so that the family may contribute to an annuity, and have income and/or a lump payment from the annuity. In this embodiment, the FPDA premiums may be paid by the increase in the income tax refund due to additional tax savings resulting from the higher amount of home mortgage interest deductible each year. Alternatively, in yet another useful embodiment, the increased income tax savings may be used to fund additional purchases of tax efficient mutual funds.

In the aforementioned embodiments where the family is not drawing from the principal of the SPIA, the SPIA principal would remain available at the end of the SPIA term, and the FPDA would also be available at the end of the FPDA term. However, should the income from the SPIA alone not be sufficient to cover college costs, many annuities permit the annuity purchaser to draw out the principle in addition to the interest. Referring back to Family B, purchasing an annuity for $325,000 at 8%, and drawing out the principal would allow for constant payments of $44,846 each year for 10 years. Compared to $26,000 in interest alone from the SPIA, the $44,846 would most likely suffice to pay for most of a student's college costs, as well as the increased mortgage payment incurred. While the 10 year period for the SPIA is significantly shorter than the 30 year mortgage, it should be noted that, assuming an 8% return, the FPDA funded from the increased tax savings would result in a payment of approximately $65,000 at the end of the 10 year term as well.

It should be noted that the anticipated costs and needs determined based on the initial needs determination in step 102 may cause the amount of leveraged assets to vary significantly. For instance, where a student is attending a public college, the associated tuition costs may be lower, and the calculated asset amount needed to be leveraged to cover the college costs will be lower as well. In such a situation, a refinancing mortgage for a smaller amount may be appropriate. Similarly, higher college costs will necessitate a greater amount of assets being leveraged to cover the higher college costs.

Any shortfall in covering the college costs annuities' yearly return may be advantageously covered by federal grants, institutional and private scholarships, and federally subsidized and private loans.

The development of the asset structuring plan may also include a calculation to compensate for the rising cost of college as the student attends. Furthermore, advantageous embodiments of the asset structuring plan calculation may include calculation of free cash flow over any number of future years, asset liquidity reports, or the like.

After all of the elements of the asset structuring plan are calculated in step 108, the plan is then reviewed by the client in step 110. In one useful embodiment, the client may be given a list of strategies and suggestions for leveraging the family's assets to pay college costs. The presentation of the plan may also optionally include reports detailing aspects of the plan such as a summary, free cash flow, school expense projection, CSS and PROFILE formula calculations, and the like.

After reviewing the plan in step 110, the client may determine if any changes are required in step 114. In particularly useful embodiments, the client may determine that they would like to leverage more or less of their assets. For example, a family may determine that they do not wish to take out a refinancing mortgage for the initial mount calculated and suggested in step 108, and may adjust the financial information and assets targets to reflect their desires in step 112. Conversely, a family who wishes to avoid taking out any loans may wish to leverage a larger portion of their assets by, for example, taking out a larger mortgage refinancing loan. Any adjustments to financial information and assets targets would be next entered on step 112, after which the asset structuring plan is recalculated in step 108.

Once the client determines that no changes to the proposed asset structuring plan are required in step 113, the plan may then be enacted in step 116. Enacting the plan entails executing the suggestions and strategies for restructuring assets that were calculated in step 108. In particular, a client may, with the assistance of a financial advisor, structure assets in step 130 by performing a mortgage refinancing in step 141, purchasing insurance in step 140, purchasing interest bearing annuities in step 142, purchasing tax efficient mutual funds in step 145, reallocating assets in step 143 to prevent the assets from being considered in financial aid calculations, making additional non-taxable contributions in block 144, or any other step involved in advantageously structuring assets.

After the plan has been enacted in step 116, financial aid processing takes place in step 118. In one useful embodiment, the CSS/PROFILE financial aid forms and the FAFSA financial aid forms may be completed on behalf of the client. In one useful embodiment, the financial aid forms may be filled in using a combination of the original financial aid information entered in step 104, and the new financial information based on the anticipated execution asset structuring plan as calculated in step 108.

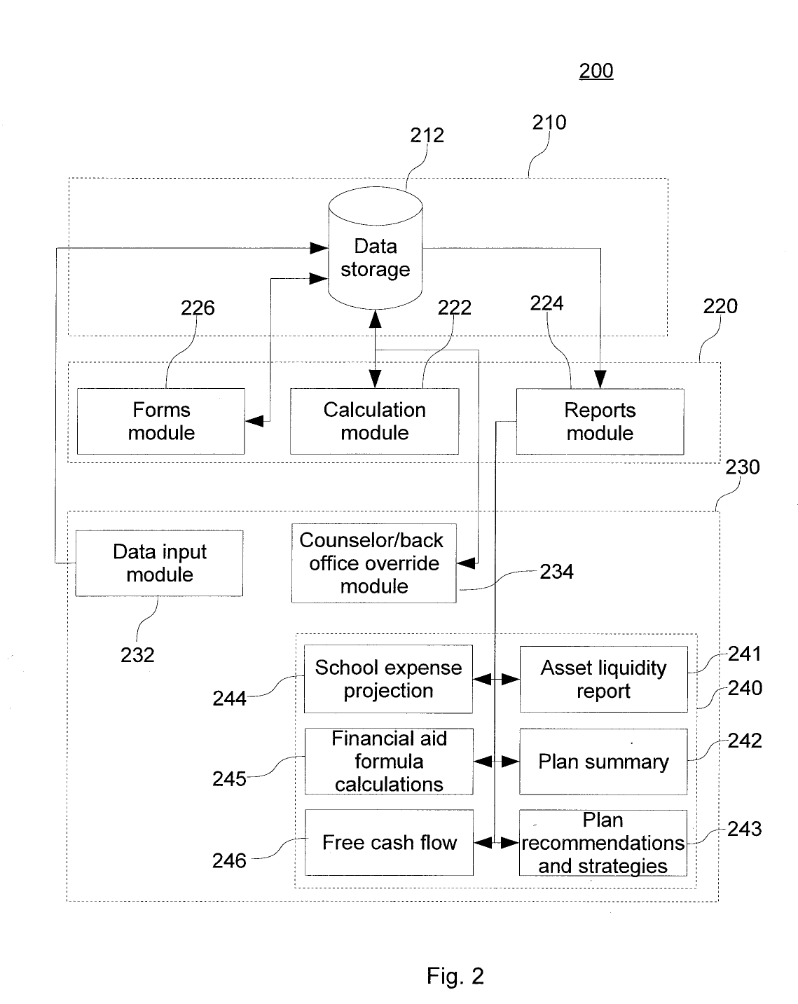

FIG. 2 is block diagram of an illustrative embodiment of a system 200 for developing a higher education financing plan in accordance with the present principles. The system 200 may be implemented in whole or in part via computer software, on a website, or through a standalone computer program, spreadsheet, or the like.

In one preferred embodiment, the system 200 may include a data storage layer 210, a middleware layer 220, and an interface layer 230.

The storage layer 210 may advantageously have data storage 212 such as a database or any other data storage medium. Alternately, the data storage may be a flat digital file, a spreadsheet, or the like. In yet another embodiment, the data storage may be simply hard copies of the information submitted by a system user.

An interface layer 230 may be comprised of a data input module 232, counselor/back office override module 234, and an output module 240. The interface layer 230 may include a data input module 232 configured to allow entry of financial information such as income, assets, tax information, deductions, pension plan information, anticipated college costs, additional children attending college now or in the future, cash flow, or any other information useful for determining the optimum strategy for leveraging a client's assets to cover college costs.

In one particularly useful embodiment, the interface layer may be implemented as a website, allowing clients and/or financial advisors and counselors to input data, correct and modify data, and run and view reports on a proposed asset structuring plan.

Alternatively, the interface layer 230 may be implemented, in whole or in part, as a series of standalone programs such that users would be able to interact with various interface portions of the system 200 without necessarily needing an internet connection. For example, the data input module 232 may be an electronic questionnaire not connected or originating from a website, while the data storage layer 210, middleware layer 220, and other elements of the interface layer 230 reside on a server or other computer. A financial advisor or counselor may deliver the electronic questionnaire to the client on a disk, CD, or via email, for example. The client would then have the opportunity to enter financial information and the like at their leisure, and then return the electronic questionnaire to the financial advisor. The financial advisor would then transfer the information entered into data storage 212, after which the information may be accessed to develop the asset targets and asset structuring plan.

The counselor back/office override module 234 may permit a counselor or other member of the financial advisor's team to review a client's financial information, and make adjustments to account for errors, incorrect assumptions, changes to the client's financial situation, or the like. This override module 234 may be useful in embodiments where the financial advisor or counselor have presented an initial asset structuring plan to a client, as in step 108, described above, and the client wishes to modify the asset targets or any portion, calculation, assumption, recommendation, or the like, used or generated during the asset structuring plan development.

The middleware layer 220 is generally comprised of business logic that is dedicated non-interface and non-storage functions. In one useful embodiment, the middleware layer 220 may be comprised of a calculation module 222, a reports module 224 and a forms module 226. The calculation module 222 may be bidirectionally connected to the data storage 212 such that the calculation module 222 may load information from the data storage 212, perform necessary calculations, and save any changed or new information to the data storage 212.

In particularly useful embodiments, the calculation module 222 may read data from data storage 212, including the financial information input in step 104 through the data input module 232. The calculation module 222 may then calculate asset targets, as described in step 106, and automatically develop an asset structuring plan, as described in step 108.

The calculation module 222 may be invoked automatically, for example, when all of the data necessary to generate an asset structuring plan has been entered. This may advantageously permit a client or other data entry person to enter data in various stages. Such automated triggers are well known to artisans skilled in data processing, and may include database triggers, inter-process communications between the data input module 232 and the calculation module 222, scanning for changes in the database by the calculation module 222, or any other trigger, known or as yet undiscovered.

Alternatively, the calculation module 222 could be invoked to generate the asset targets and asset structuring plan upon a manual instruction from a user. For example, a financial advisor may manually cause execution of calculations by the calculation module 222. For instance, a counselor may enter the counselor/back office override module 234, and, after any changes, execute the asset target calculation and asset structuring plan development calculations by the calculation module 222 just prior to reviewing the resulting reports. For instance, in one useful embodiment, when a financial advisor desires to view the asset structuring plan and accompanying reports for a particular client, the financial advisor may select the client reports in a user interface, and the calculation module may generate the asset structuring plan and the reports module 224 may generate the associated reports, on the fly, i.e. upon the advisor's request, just prior to generating the requested reports.

One particularly advantageous embodiment may be where the asset structuring plan is only generated a single time after each change to the underlying user data takes place. In this embodiment, the asset structuring plan and associated reports may be generated the first time a user views the reports, and the asset structuring plan and associated reports may be saved to data storage after initial generation, and recalled when the user views the plans subsequently. Additionally, the asset structuring plan may be regenerated if the client or financial advisor changes any assumptions, target financial information, or any other data, with the associated reports regenerated when the asset structuring plan is regenerated.

The reports module 224 may, in particularly advantageous embodiments, generate reports including, but not limited to, a plan summary 240, asset liquidity reports 241, plan recommendations and strategies, free cash flow reports 246, school expense projections 244, financial aid formula calculations, and the like.

The forms module 226 may also be part of an advantageous middleware layer 220. In particularly useful embodiments, the forms module 226 may automatically fill out forms associated with financial aid, including, but not limited to, FAFSA and CSS/PROFILE applications, loan applications, and the like. In this embodiment, the forms module 226 may retrieve financial and any other information required for the forms from data storage 212. It should be noted that with the rise in electronic applications, advantageous embodiments of the forms module 226 may be configured to fill in and pre-populate electronic forms residing on other computer systems, or to submit data formatted according to specifications of financial aid providers. Additionally, in another embodiment, the forms module 226 may generate hard copies of completely or partially completed forms for later manual submission to a financial aid provider. For instance, a family may wish to review hard copies of financial aid forms, and submit hard copies the forms themselves, instead of by electronic submission. In such a situation, the forms module 226 may be directed to print paper copies of standard known forms, with information from data storage 212 already filled in. Any data required by a particular form, but not already collected, could be left blank on the forms, and filled in at a later point by a client. Alternatively, a user or client could enter the missing data, which would then be included on the forms when printed.

The data storage 212 may be used to store calculations and results from the asset structuring plan, which may suggest moving, refinancing or otherwise modifying the distribution of assets. In one useful embodiment, the information resulting from the calculation of the asset targets and asset structuring plan may be entered into any forms, where appropriate. For instance, if the asset structuring plan calls for refinancing a home and making a cash contribution to a retirement plan, the new asset value of the home may be automatically entered into the necessary spots in any forms, as the asset value is reportable at the time the form is completed. However, the retirement plan contribution may not be entered, as many retirement plan contributions are counted in the year the contribution is made, but not in later years, and such entry may not be called for at the time of the form generation. Of course, the rules and methodologies vary for each entry on each different form, each form, and each financial aid provider.

The forms module 226 may also be advantageously configured to fill out and/or submit forms for any other process involved in the asset restructuring plan. This may include, but it not limited to applications for annuities and mutual funds, applications for insurance, mortgage refinancing paperwork and the like.

Thus, when performing the method 100 for developing a higher education financing plan of FIG. 1 using the system as described in FIG. 2, a financial advisor and their client would determine the client's initial needs, as in step 102, and then enter relevant financial information as described by step 104, into a data input module 232. The financial data entered into the data input module 232 may then be stored in data storage for alter access. Using the financial information residing in data storage, the asset targets may then be calculated, as in step 106, and an asset structuring plan developed as in step 108 by the calculation module 222. A plurality of reports 240 may be generated by the reports module 224, detailing the developed asset structuring plan. The reports may then be presented to the client for review, as in step 110, after which the client may determine whether they would like to make any changes in step 114. In the event changes the asset structuring plan or its underlying assumptions are necessary, the financial information and asset targets may be adjusted in step 112, by a counselor, financial advisor, or the like using the counselor/back office override module 234. After any necessary changes have been made and integrated into a regenerated asset structuring plan, the plan is then enacted in step 116 and financial aid applications are processed in step 118, using paperwork, applications and submissions generated by the forms module 226.

Having described preferred embodiments a system and method for generating a leveraged investment plan to provide educational funds (which are intended to be illustrative and not limiting), it is noted that modifications and variations can be made by persons skilled in the art in light of the above teachings. It is therefore to be understood that changes may be made in the particular embodiments of the present principles disclosed which are within the scope and spirit of the present principles as outlined by the appended claims. Having thus described the present principles with the details and particularity required by the patent laws, what is claimed and desired protected by Letters Patent is set forth in the appended claims.

What is claimed is:

1. A method for developing a plan to provide financial aid eligibility for families and students that would not otherwise qualify for financial aid, the method comprising:
determining financial needs of a future college student;
entering financial information of the student and the student's family into a system for developing an asset structuring plan to change asset allocation;
calculating, using a processor, asset targets based on the financial information and the financial needs;
generating, by the system, the asset structuring plan based on the asset targets, financial needs and financial information;
generating, by the system, a plurality of reports detailing the asset structuring plan, the asset structuring plan having strategies for leveraging the student's and student's family's assets to provide income to pay the student's higher education costs;
presenting the asset structuring plan for review by the student's family;
determining whether changes are required; and
changing the asset structuring plan as generated by the system and as reflected in the plurality of reports.

2. The method of claim 1, further comprising, upon determining that changes to the asset structuring plan are required:
adjusting financial information and asset targets;
re-calculating the asset targets based on the modified financial information and including any modifications to the asset targets; and
re-generating the asset structuring plan based on the re-calculated asset target and modified financial information.

3. The method of claim 1, further comprising, upon determining that no changes to the asset structuring plan are required:
enacting the plan by executing the strategies for leveraging asset of the asset structuring plan by performing at least one step from a group of method steps consisting of: refinancing at least one mortgage on real estate, purchasing annuities to provide income, purchasing mutual funds to provide income, purchasing insurance, reallocating assets, and making non-taxable contributions to a pension fund.

4. The method of claim 1, the method further comprising generating financial aid forms and populating data fields on the financial aid forms with the financial information and the results of the asset structuring plan.
